(19) United States
(12) Patent Application Publication
(10) Pub. No.: US 2025/0178693 A1
(43) Pub. Date: Jun. 5, 2025

(54) POWER-SPLIT HYBRID DRIVELINE FOR AN ELECTRIC BICYCLE

(71) Applicant: RAICAM DRIVELINE S.R.L., Mondovi' (Cuneo) (IT)

(72) Inventors: Benjamin Chetwood STRUVE', Kenilworth Warwickshire (GB); Sandro BONARDO, Peveragno (Cuneo) (IT)

(73) Assignee: RAICAM DRIVELINE S.R.L., Mondovi' (Cuneo) (IT)

(21) Appl. No.: 18/837,599

(22) PCT Filed: Feb. 8, 2023
(86) PCT No.: PCT/EP2023/053052

§ 371 Date: Aug. 11, 2024

(30) Foreign Application Priority Data
Feb. 11, 2022 (IT) 102022000002573

(51) Int. Cl. B62M 6/60; B62M 6/50; B62M 6/90; B62M 11/14

(52) U.S. Cl. CPC B62M 6/60; B62M 6/50; B62M 6/90; B62M 11/14

(57) ABSTRACT

Provided is an electric auxiliary drive system for a bicycle having a pedal crankshaft for operation by a rider, an epicyclic gearing mechanism configured to determine a transmission ratio between the pedal crankshaft and an output shaft for transmitting rotation to a rear wheel of the bicycle, an electric assist motor and an electric control motor. The epicyclic gearing mechanism has a ring gear, a sun gear secured for rotation with the output shaft, planet gears between the sun gear and the ring gear, and a planet carrier which is secured for rotation with the pedal crankshaft and supporting the planet gears. The electric assist motor has a rotor drivingly connected to the sun gear to drive the output shaft. The electric control motor is drivingly connected to the ring gear for controlling the transmission ratio between the output shaft and the pedal crankshaft.

### TECHNICAL FIELD

The present invention pertains to the field of electrically powered bicycles (or “e-bikes”) with an electric motor assisting the rider's pedal-power. More specifically, the present invention concerns a hybrid driveline for an e-bike.

### BACKGROUND ART

Most e-bike drivelines of known design are simply adapted from conventional bicycle drivelines, in particular the gearing mechanisms which are usually derailleur or hub gear systems. These systems have the drawbacks of poor durability when exposed to the additional torque generated by the electrical assistance motor or poor efficiency. In addition, there are benefits to be gained from controlling the gear-ratio between the pedals and the rear wheel. Integrating the control over the assistance motor and the gear ratio allows the demands on the rider to be minimised, thereby reducing their exhaustion, and also reducing electrical consumption.

The power split hybrid concept is well known in automotive engineering, and has also been proposed for e-bikes within academic research. This proposal describes a practical mechanical implementation of the concept, which has the possibility of being packaged in between the pedals of a bicycle.

Up until today, e-bikes generally use standard bicycle components for their drivelines. Regardless of whether the assistance motors are mounted within the centre of the frame or inside a wheel hub, the drive and gearing mechanisms connecting the pedals to the rear wheel usually consist of a drive chain or belt, and a hub mounted gear-system or derailleur system for changing ratios. Usually, selection of gears is manual and at the discretion of the rider.

A few systems have been marketed which attempt to improve upon traditional driveline concepts—an example is the NuVinci Continuously Variable Planetary Transmission, which is a hub mounted system offering a continuously variable gear ratio which may be electronically shifted and may be interfaced with the controller for the electrical assist motor. See WO 2005/019686 A2.

The concept of hybridising a vehicle powertrain (by providing an electric machine or machines coupled to an electrical energy store) has been investigated in great detail within the automotive industry, where efficiency benefits have been realised by enabling a combustion engine to be sized to generate only the mean power required to drive a vehicle, whilst relying on stored energy to supplement this when peak power is required (for example when accelerating or climbing a hill). Notably, in the automotive industry, a hybrid drive system has very successfully employed an epicyclic gear system to couple a combustion engine with two electric machines to give a flexible and efficient hybrid driveline concept. Exemplary patent publications disclosing ‘power-split’ layout are JP H0946821 A, EP 0791495 A2 and US 2004/00550597 A1.

The objectives behind providing electrical assistance to a bicycle, in order for the rider to provide only the mean power required to move the vehicle, whilst the electrical machine assists during acceleration or climbing hills, are very similar to the requirements for a combustion engine hybrid vehicle. The potential of applying the ‘power-split’ vehicle driveline concept to a bicycle was identified academically in 2014 by Chen, Li and Pen, and presented at the ASME Dynamic Systems and Control Conference (DSCC2014). They presented simulation and research into the benefits of employing such a system on a bicycle, particularly in reducing fatigue for the rider.

WO 2020/260772 A1 discloses a power unit for pedal vehicle. The power unit comprises a pedal shaft, an output shaft arranged to transfer torque to a vehicle wheel, a main epicyclic gear set arranged to control transmission ratio between the pedal shaft and the output shaft, an assist motor connected to an assist gear of the main epicyclic gear set, and a control motor connected to a control gear of the main epicyclic gear set. The control motor and the control gear form a control assembly of the power unit. The power unit comprises a one-way clutch associated with the control assembly of the power unit and arranged to transmit rotation in only a first rotation direction.

DE 10 2017 003945 A1 discloses an electric auxiliary drive system for a bicycle, comprising an assist motor, a control motor, a pedal crankshaft for operation by a rider, and an epicyclic gearing mechanism arranged to determine the transmission ratio between the pedal crankshaft and an output shaft for transmitting rotation to a rear wheel of the bicycle. The assist motor and the control motor are designed as hollow-shaft drives with internal teeth engaging respective sets of planets of epicyclic gears. A first set of planet gears engaged by the assist motor have their planetary carrier in common with the planetary carrier of a second set of planet gears engaging the sun gear, which is secured for rotation with an output shaft, and a ring gear. This ring gear is rigidly connected to the planetary carrier of a third set of planet gears driven by the internal teeth of the control motor. The speed of the control motor determines the speed of the ring gear and thus the transmission ratio between the pedal crankshaft and the output shaft.

### SUMMARY OF THE INVENTION

Against the foregoing background, the present invention provides an electric auxiliary drive system for a bicycle, having the features defined in claim 1. Preferred embodiments are defined in the dependent claims.

According to an aspect, the drive system comprises a pedal crankshaft for operation by a rider, an epicyclic gearing mechanism, an assist motor and a control motor. The epicyclic gearing mechanism is arranged to determine the transmission ratio between the pedal crankshaft and an output shaft for transmitting rotation to a rear wheel of the bicycle. In the epicyclic gearing mechanism, a sun gear is secured for rotation with the output shaft, a set of planet gears are arranged between the sun gear and a ring gear. A planet carrier is secured for rotation with the pedal crankshaft and supports the planet gears. The assist motor has a rotor drivingly connected to a gear secured to or integral with the sun gear, in order to drive the output shaft. The control motor is drivingly connected to the ring gear for controlling the transmission ratio between the output shaft and the pedal crankshaft.

### BRIEF DESCRIPTION OF THE DRAWINGS

In order that the present invention may be well understood there will now be described a few preferred embodiments thereof, given by way of example, reference being made to the accompanying drawings, in which:

FIG. 1 is a schematic cross-sectional view of the main components of an e-bike drive system according to an embodiment of the present invention;

FIG. 2 shows a close-up view of the mechanical layout of the electric motors and an epicyclic gearing mechanism of FIG. 1;

FIG. 3 diagrammatically shows the torque split relationship through the epicyclic gear mechanism;

FIG. 4 is a diagram showing the electrical power flow through the system during normal pedalling;

FIGS. 5A and 5B are simplified diagrams showing the speed relationship between various elements of the epicyclic power-split gearing mechanism, respectively while starting the bicycle and while cruising;

FIG. 6 is a diagram showing the electrical power flow through the system during regenerative braking;

FIG. 7 is a schematic cross-sectional view of the main components of an e-bike drive system according to an alternative embodiment of the present invention, with the electric motors mounted at the side of the epicyclic gear mechanism;

FIG. 8 is an enlarged cross-sectional view showing the drive unit according to the alternative layout of FIG. 7;

FIG. 9 is a cross-sectional view of an embodiment of the e-bike drive system including a device offering a fixed gear ratio to allow the bicycle to be ridden with a flat battery;

FIGS. 9A and 9B are enlarged views of a detail of FIG. 9, in two different operational conditions;

FIG. 10 is a cross-sectional view of an embodiment of the e-bike drive system including a mechanical freewheel device; and

FIG. 11 and FIG. 12 are schematic views of two different freewheel devices that may be incorporated in the e-bike drive system.

### DETAILED DESCRIPTION

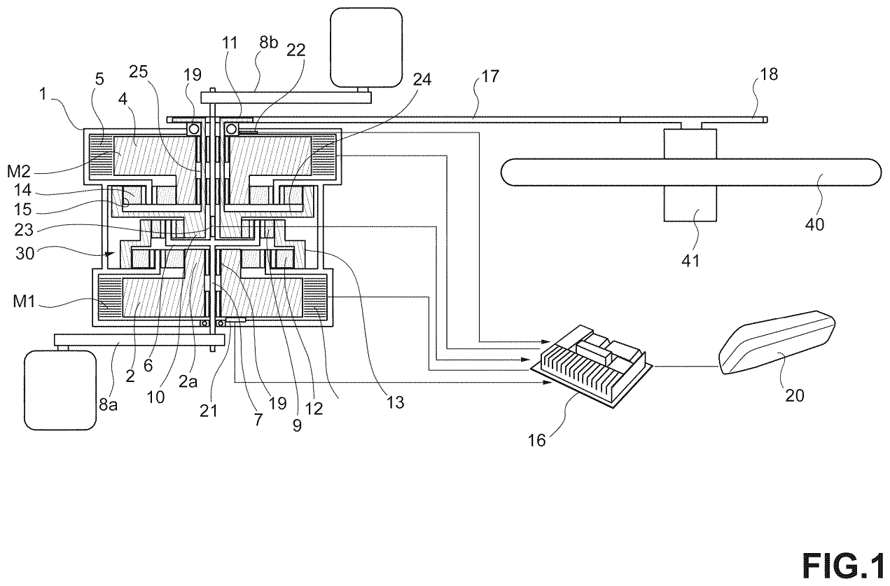

Referring initially to FIG. 1, an e-bike drive system comprises a housing 1, which may be mounted in use centrally within the frame of a bicycle (at the ‘bottom bracket’). The housing 1 contains two electric motors, M1, M2, and an epicyclic gearing mechanism 30 having an output shaft 25. Secured for rotation with the output shaft 25 is a chain ring 11 that drives the rear wheel 40 of the bicycle.

The housing 1 provides mountings and reaction points the rolling bearings 19 rotatably supporting a pedal crankshaft 7 and may also contain an electronic controller 16 for the drive system.

Electric motor M1 is termed “control” motor, because it drives a gear of the epicyclic gearing mechanism that controls the transmission ratio between the output shaft and the pedal crankshaft.

Electric motor M2, termed “assist” motor herein, generates power that is transmitted to the output shaft 25.

In this context, the epicyclic gearing mechanism is also referred to as an epicyclic “power-split” gearing mechanism, because it is arranged to transfer power from the pedals to the rear wheel of the bicycle through two routes, as explained herein after: a mechanical route and an electrical route. Specifically, the epicyclic gearing mechanism transmits power from the assist motor M2 to the output shaft. Furthermore, the epicyclic gearing mechanism adjusts the rotational speed of the pedal crankshaft 7 as a result of the operation of control motor M1.

Designated at 2 is a rotor of the control motor M1, with stationary windings 3. Preferably, the control motor M1 is an AC, brushless, synchronous motor arrangement, also known as a PMSM—Permanent Magnet Synchronous Motor. The control motor may have a maximum steady state power of about 150 W, and a peak power of about 300 W. By way of indication, the maximum speed of this motor may be approximately 1600 rpm.

The assist motor M2, which comprises a rotor 4 and stationary windings 5, may also be a PMSM motor.

Preferably, the assist motor M2 has a maximum steady state power of about 250 W, and a peak power of about 500 W. The maximum speed of this motor may approximately be 3000 rpm.

The epicyclic gearing mechanism 30 comprises a planet carrier 6 for planetary gears 9. The carrier 6 is secured for rotation with the pedal shaft 7.

A torque sensor 23 may be incorporated within the pedal shaft 7 or the planetary gear carrier 6 to detect the pedalling torque applied to the system by the rider.

The pedal shaft 7 passes through the entire assembly from side to side and connects together left and right pedal crank assemblies 8a, 8b, each of which comprises a crank arm and a pedal which is mounted to the arm by a rotating joint, in a conventional manner.

The planetary gears 9 of the power split gearing mechanism 30 are mounted on the carrier 6 using bearings which allow free rotation of the gears 9 relative to the carrier 6.

The power split epicyclic gearing mechanism 30 comprises a sun gear 10 which is driven for rotation by the assist motor M2 and is secured for rotation with the chain-ring 11 located on the right side of the system.

The sun gear 10 is secured to or integral with the chain-ring 11 through the output shaft 25, which may be in form of an axially extending central tubular portion that surrounds coaxially a length of the pedal crankshaft 7.

Further, the sun gear 10 is secured to or integral with a gear 15 in order to be drivingly connected, either directly or through a set of reduction gears 14, with the rotor 4 of the assist motor M2.

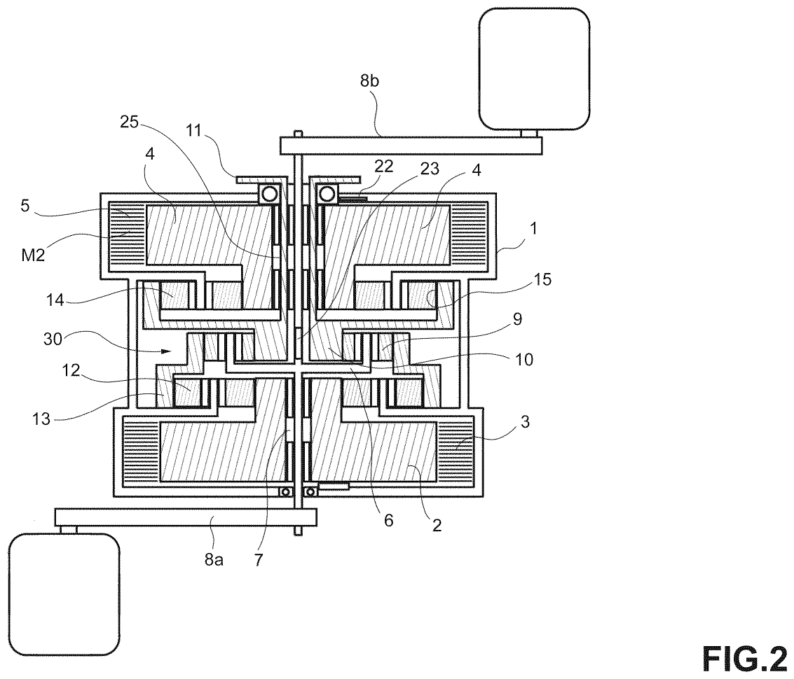

In accordance with the embodiment illustrated in FIGS. 1 and 2, the gear 15 that receives the driving torque originating from the assist motor M2 is in form of an internally toothed ring gear 15.

The sun gear 10, the output shaft 25 and the gear 15 that received the driving torque of assist motor M2 may are secured together for rotation as a unit. Embodiments may provide that the sun gear, the output shaft 25 and the gear 15 may be in formed in a single piece or composed of separate parts fixedly secured together.

According to a preferred embodiment (as shown for example in FIGS. 1 and 2), the sun gear 10 is driven by the output shaft of the rotor 4 of the assist motor M2 through a set of reduction gears 14 acting between the output shaft 25 and the sun gear 10.

In the exemplary embodiment illustrated in FIG. 1, the sun gear 10 may be formed with or secured to a radial extension 24 that provides the gear 15 in form of an internally toothed peripheral ring gear 15 that meshes with the reduction gears 14. Conveniently, the reduction gears 14 may be mounted for free rotation about respective stationary axial supporting pins integral with the housing.

The chain-ring 11 has a peripheral shape which allows it to drive a sprocket 18 mounted to the rear wheel hub 41 of the bicycle via either a flexible transmission means 17, such as a roller chain or a toothed polymer belt ring, and the sprocket 18. The rear wheel is designated at 40. The sprocket 18 may be a fixed sprocket without any free-wheel or gearing devices.

Preferably, the chain-ring/rear sprocket transmission ratio is numerically less than 1.

The rotor 2 of the control motor M1 transfers drive to a ring gear 13 which meshes with the planetary gears 9 (which are mounted on the carrier 6 that is secured for rotation with the pedal crankshaft). Furthermore, the rotor 4 of the assist motor M2 transfers drive to the sun gear 10 through the planetary gears 9.

According to a preferred embodiment, as shown in FIG. 1, the ring gear 13 is configured with a dual set of teeth, arranged to mesh both with the planetary gears 9 and a set of planetary reduction gears 12 which mesh with and are driven by an output shaft 2a of the rotor 2 of the control motor M1.

Preferably, the reduction gears 14 of the assist motor M2 are mounted for free rotation about respective stationary axial supporting pins integral with the housing.

According to the exemplary and particularly compact design of the embodiment illustrated in FIG. 1, the dual set of teeth are formed as internal toothings on the ring gear 13.

Embodiments may provide, as illustrated in the example of FIG. 1, that the toothings of the dual set of toothings on ring gear 13 are provided on axially staggered or axially offset portions of the ring gear 13. Alternative embodiments (not shown) may provide that the dual set of toothings are arranged one on the radially inner surface and the other on the radially outer surface of the gear ring. Whereas in the example depicted in FIG. 1 the toothing of the gear ring 13 meshing with the reduction gears 12 is set on a larger diameter than the toothing meshing with the planetary gears 9, alternative embodiments (not shown) may either provide a same diameter for both toothings, or a wider diameter for the toothing meshing with the planetary gears 9.

A number of rolling bearing elements, such as those designated at 19, are included within the mechanism to support and allow rotation between the motor rotors, the epicyclic gear elements and the pedal crank shaft.

A first rotation sensor, preferably an angular position sensor 21 measures the angular position of the rotor 2 of the control motor M1 relative to the housing 1. A second rotation sensor, preferably an angular position sensor 22 measures the angular position of the rotor 4 of the assist motor M2 relative to the housing 1.

An electronic controller 16 which receives information about the angular positions of the control and assist motors from angular position sensors 21, 22, and the torque applied to the pedals by the rider from a torque sensor 23. Using this information, the controller 16 computes the actual speed of the bicycle and of the pedals and the effort of the rider, and using a pre-determined control strategy computes the desired level of torque assistance and the desired speed ratio between the pedals and the bicycle wheels. The controller consequently commutates the current within the windings 3 and 5 of electric motors M1 and M2 according to the measured angular positions of their corresponding rotors (2 and 4) in order to achieve a speed set-point at control motor M1 and a torque set point at assist motor M2. Internal power circuitry within the controller 16 is arranged so that motor 1 and motor 2 may both function as either motors or as generators, and so that electrical power may flow in any direction between the either of the motors and a battery 20. The battery 20 provides necessary electrical energy to assist the rider in powering the bicycle.

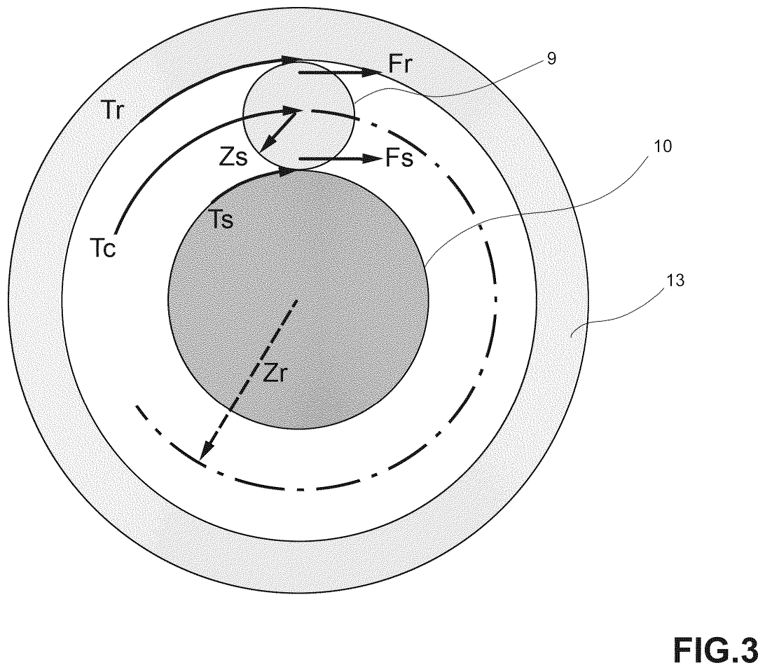

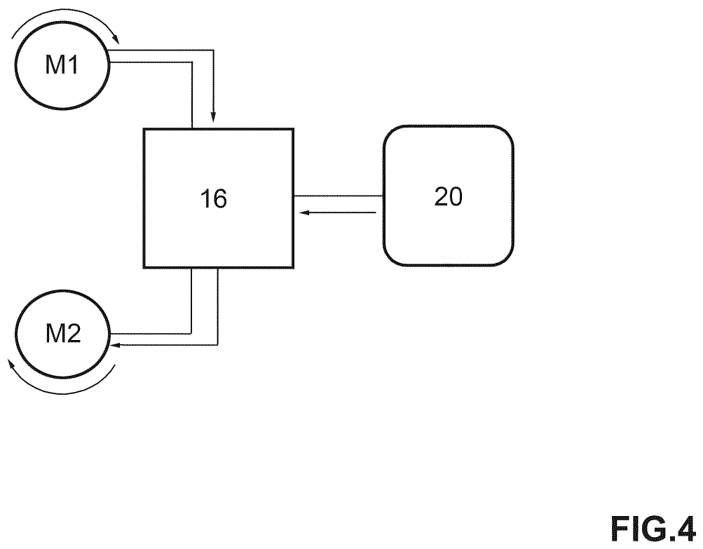

During operation, when torque from the pedals is applied to the planetary carrier 6, the torque is distributed via the planetary gears 9 to both the sun gear 10 and the ring gear 13. The relationship between these torques is shown in FIG. 3. The torque applied to the sun gear 10 is directly transmitted to the chain-ring 11 and hence to the bicycle wheel 40 (this is the “mechanical route” mentioned herein above). The torque applied to the ring gear 13 is transmitted to the rotor 2 of the control motor M1, which consequently generates electrical power which is supplied to the electrical power circuit within the electronic controller 16. This electrical power is then supplied to the assist motor M2, whose rotor 4 is connected via its reduction gearing 14 to the sun gear 10, which hence assists in powering the bicycle. If additional assistance is desired, additional power is supplied from the battery 20 to the assist motor M2 and the level of assistance is increased. FIG. 4 shows the flow of electrical power through the system during normal pedalling.

FIG. 3 diagrammatically shows the torque split relationship through the epicyclic gear mechanism. In FIG. 3:
Tc=torque applied to the carrier 6;
Zr=radius of the carrier 6;
Zs=radius of the planetary gears 9;
Fr=tangential force applied to the ring gear 13;
Fs=tangential force applied to the sun gear 10,
   where:

$$Fr = Fs = \frac{1}{2} \frac{T c}{Z r}$$

Tr=torque applied to the ring gear

$$Tr = Fr ( Z r + Z s )$$

Ts=torque applied to the sun gear 10

$$Ts = Fs ( Zr - Zs )$$

The electrical power flow through the system during normal pedalling is discussed with reference to FIG. 4. When pedalling the bicycle normally, the control strategy for the electric motors is as follows. The electronic controller 16 varies the electrical current passing through the windings of the motor M1 in order to maintain a requested speed, regardless of the torque applied to the control motor M1. The requested speed set-point of this motor is selected in order to achieve a desired pedalling speed for the rider, in order to maximise rider comfort and minimise exhaustion. In order to compute the desired pedalling speed (i.e. the desired rotational speed of the planetary carrier 6), it is first necessary to measure the speed of the sun gear 10. This may be directly inferred using the angular position sensor 22 for the assist motor M2. The desired speed of the ring gear 13 may then be calculated in real-time, and hence the speed of the control motor M1.

The speed relationship between the elements within the power split epicyclic gear mechanism are given by the following equation:

$$Ws * Zs + Wr * Zr = Wc * ( Zr + Z s )$$

### Where:

Ws=Rotational speed of the sun gear
Wc=Rotational speed of the planetary carrier
Wr=Rotational speed of the ring gear, and
Zr and Zs are the radii of the mechanism which define the lever ratios within the epicyclic gear mechanism, as described graphically in FIG. 3.

Therefore, in order to achieve a desired pedalling speed Wc, the speed of motor 1 should be

$$Wm 1 = M 1 n * Wr = M 1 n * [ Wc * ( Zr + Z s ) - Ws * Zs ] / Zr$$

### Where:

Wm1=Speed of the control motor M1
M1n=Ratio of the reduction gearing of control motor M1.

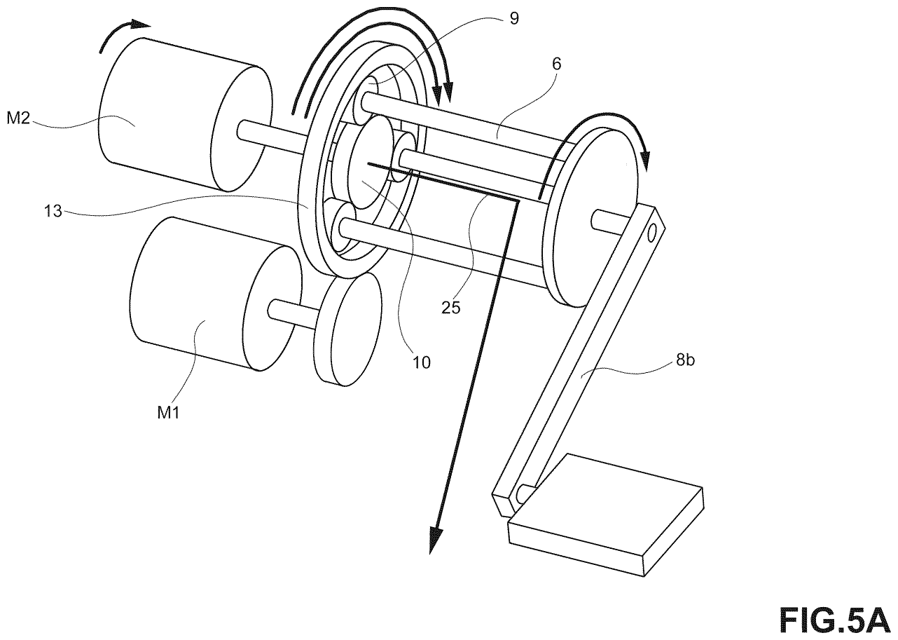

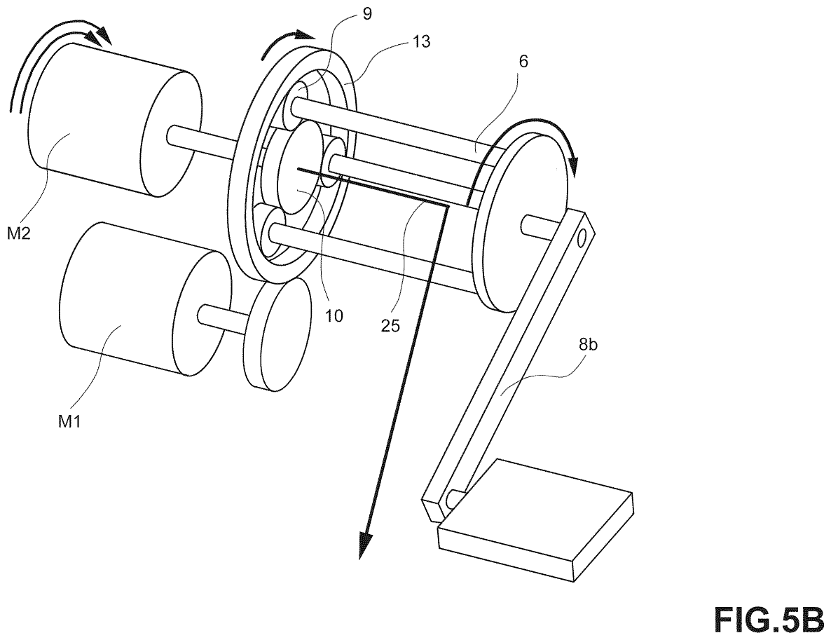

The speed relationship between the planetary carrier 6, the sun gear 10 and the ring gear 13 is shown in a highly simplified graphical form in FIGS. 5A and 5B. The reduction gears 14 for the control motor are not represented in these diagrams.

FIG. 5A depicts the situation when the bicycle is moving slowly. In order to maintain a comfortable pedalling speed for the rider, it is desirable for the pedals to turn more quickly than the sprocket 18. The control motor M1 should turn the ring gear 13 at a higher speed than the pedals in order to maintain the required pedalling speed.

FIG. 5B depicts the situation when the bicycle is cruising, i.e. moving quickly. In order to maintain rider comfort, the pedals should be turning more slowly than the front chain sprocket 18. The control motor M1 is therefore required to turn the ring gear 13 more slowly than the pedals in order to maintain the required pedalling speed.

Various strategies or operational modes may be employed in order to determine the torque set-point for the assist motor M2. For instance, an ‘assistance mode’ may be selected whereby the control system measures the torque or power supplied by the rider to the system. The torque may be calculated in real time by measuring the torque applied by the rider using the torque transducer 23, and the speed of the two motor rotors 2 and 4 using the angular position sensors 21 and 22. A proportional assistance power may then be determined, based on a desired level of assistance specified by the rider. Alternatively, a ‘charge sustaining’ mode may be selected, where a negative torque set-point is applied to the control algorithm for the assist motor M2 during certain riding conditions, for example when riding at a steady speed on level or slightly down-hill road gradients. By applying a negative torque set-point, the assist motor M2 functions as an electricity generator under these road conditions, and generated energy may be stored by the battery 20 which may then be re-used during accelerating or hill-climbing manoeuvres. The useable range of the electrical assistance system may be extended without exposing the rider to undue additional exhaustion.

Using the maximum speed and power characteristics for electric motor M1 and electric motor M2 already suggested, typical values for the motor reduction gear ratios, planetary gear ratios and chain-ring/rear sprocket ratios may be as follows. It is assumed that the e-bike is fitted with conventional touring wheels and tyres and that assistance is limited to 25 km/h (the maximum legal speed for e-bike assistance within some jurisdictions):
reduction ratio of the control motor M1 (i.e. the velocity of the control motor M1)/(power split epicyclic ring gear velocity)) should be in the order of 15;
reduction ratio of the assist motor M2 (i.e. (the velocity of the assist motor M2)/(power split epicyclic sun gear velocity)) should be in the order of 10;
the planetary gear ratio (i.e. Zr/Zs) should be in the order of 3.5;
the chain or belt system ratio, i.e. (number of teeth on the chain-ring)/(number of teeth on the sprocket) should be in the order of 0.8.

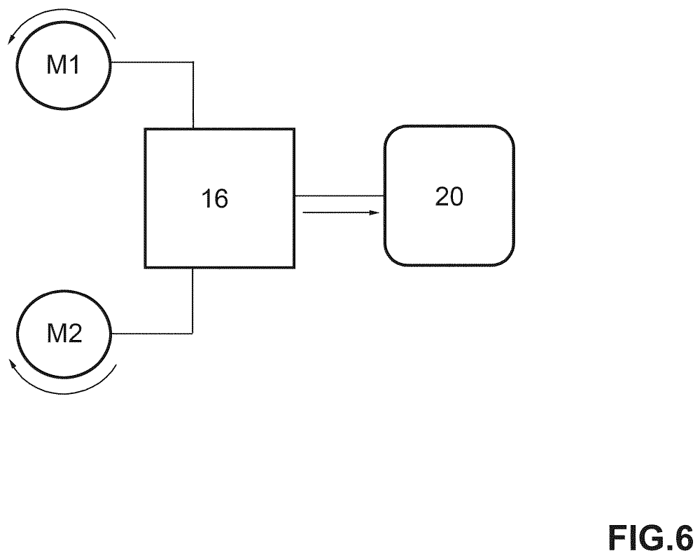

FIG. 6 illustrates the electrical power flow through the system whilst braking with stationary pedals. When slowing down the bicycle, a different set of control strategies may be employed. It is expected that, when the bicycle is slowing down, the rider will wish to stop pedalling the bicycle or ‘freewheel’. This function may be achieved without the use of a specific freewheel device, by controlling the speed of the control motor M1 with respect to the speed of the sun-gear 10 within the planetary mechanism. By substituting a desired planetary carrier speed Wc of 0 into the previous equation, the following speed set-point for the control motor M1 is as follows:

$$Wm 1 = M 1 n * Wr = - M 1 n * Ws * Zs / Zr$$

i.e. the pedal speed may be controlled to 0 if the control motor M1 is spun in the reverse direction at the appropriate speed. It is not expected that any significant torque will be applied by the rider to the pedals during this condition, therefore no significant torque will be supplied to the control motor M1. It is only necessary to supply minimal energy to the control motor M1 to rotate it at the necessary speed.

Additionally, if an electrical signal can be supplied to the controller 16 by the bicycle braking system (for example a switch fitted to the rear brake lever), a negative torque set-point may be applied to the controller for the assist motor M2, which will function as a generator whilst applying a braking torque through the drive-line and consequently allow some electrical energy to be recovered and stored within the battery 20.

According to a particularly compact embodiment, as shown in FIG. 1, the electric motors M1 and M2 are axially aligned and concentrically arranged around the pedal crank shaft 7.

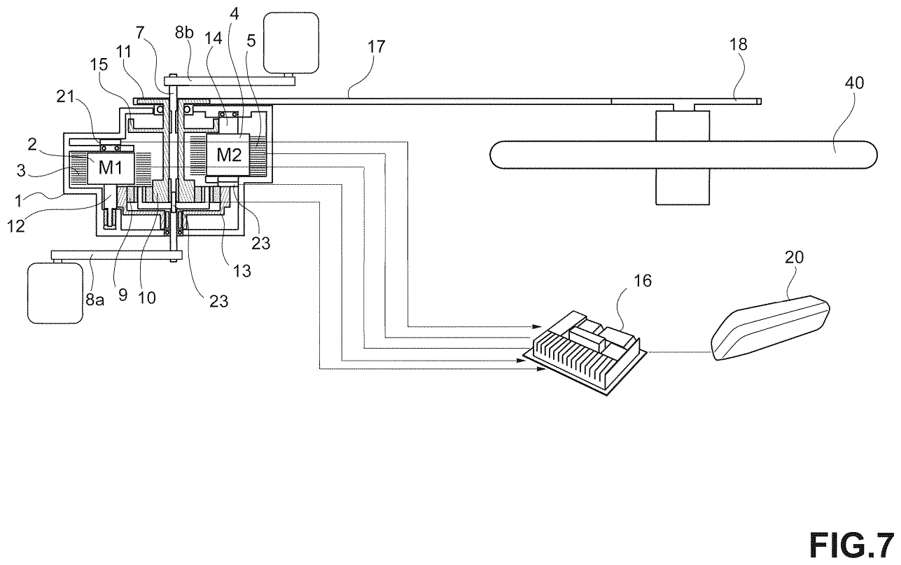

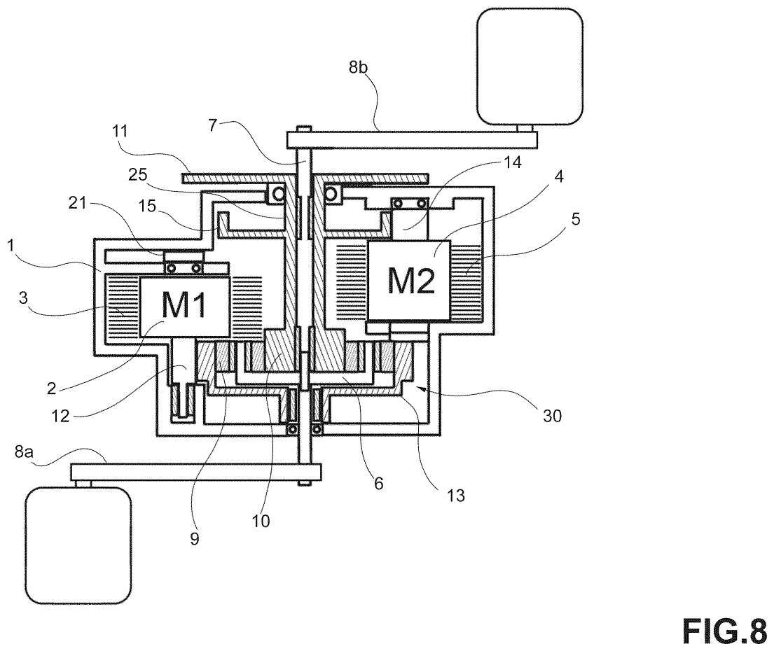

Alternative embodiments are also proposed to the system outlined in FIG. 1. One alternative mechanical layout for the electric motors and the power split epicyclic mechanism is shown in FIGS. 7 and 8, where the electric motors M1 and M2 are mounted to the side of the epicyclic gear mechanism (instead of concentrically), and the motor reduction gearing is achieved using spur gears instead of epicyclic arrangements. The arrangement may be less compact than the concentric arrangement proposed in FIG. 1, however the benefits are a reduced part count and potentially simpler motor technology which may lead to a lower cost system.

In the embodiment of FIG. 8, the gear 15 driven by the rotor 4 of the assist motor M2 is an outwardly toothed peripheral gear secured for rotation or integral with the sun gear 10 and the output shaft 25.

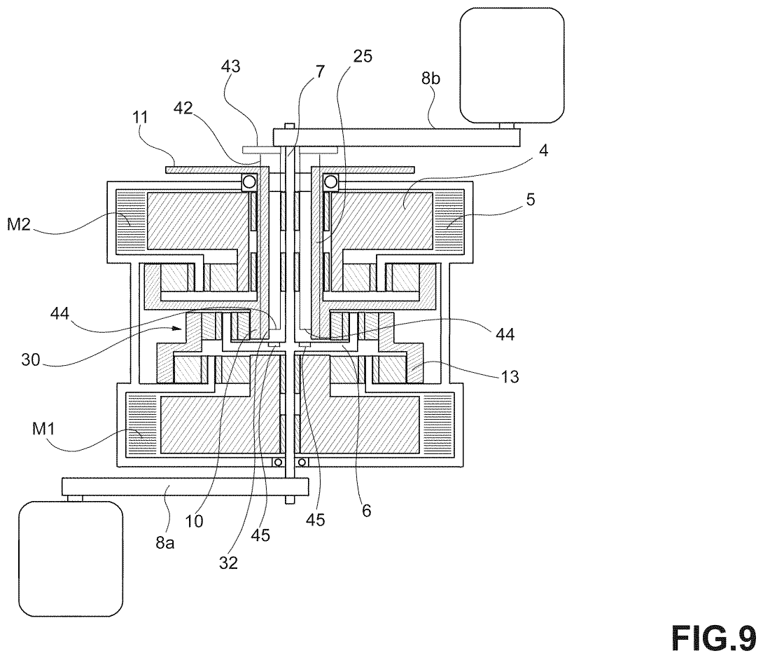

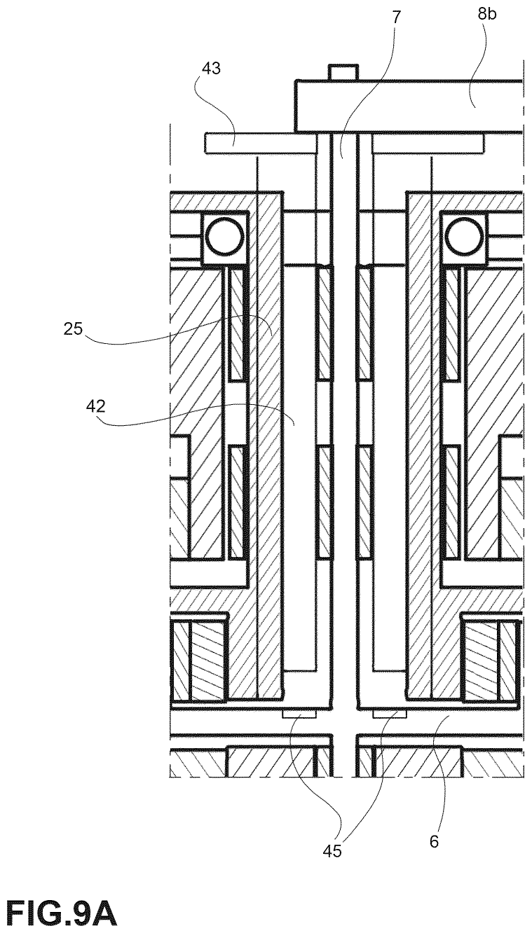

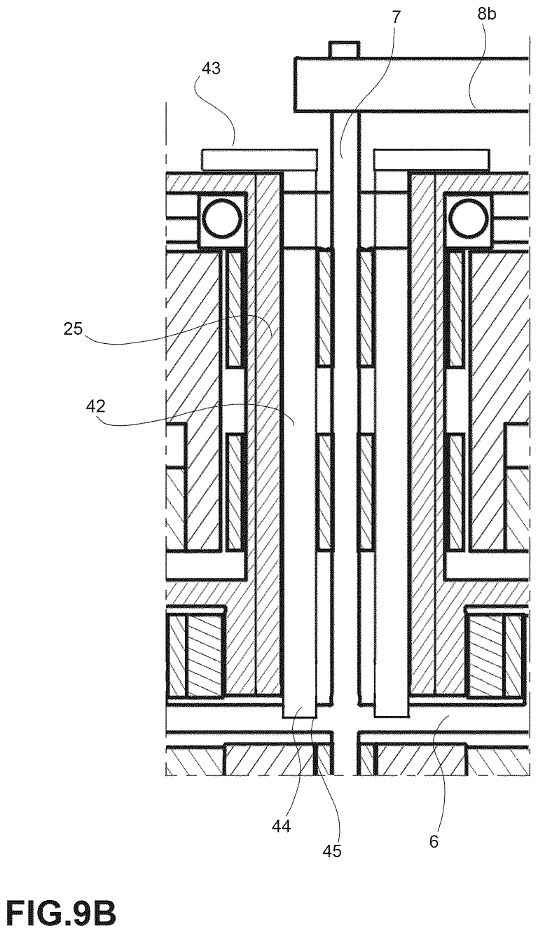

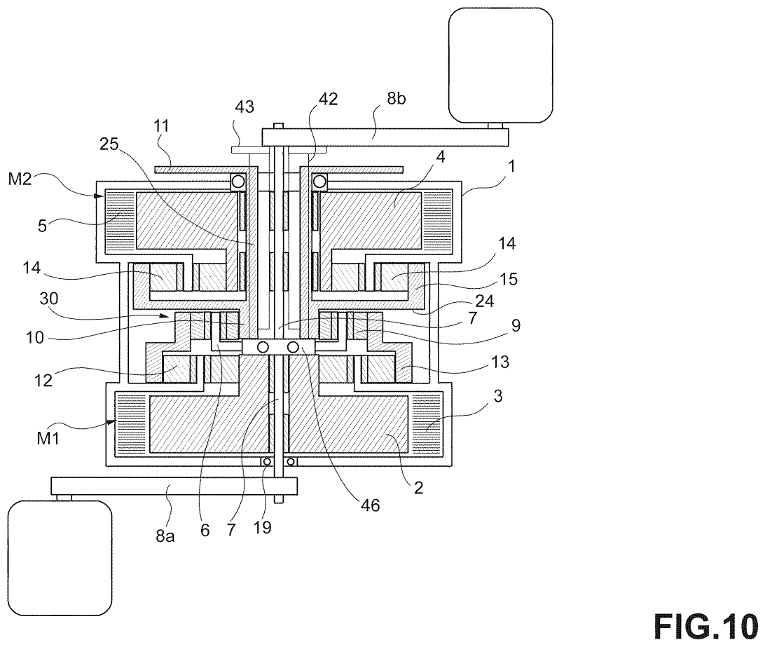

Further embodiments are schematically shown in FIGS. 9, 9A, 9B and 10, disclosing additional features any of which may be implemented in the embodiment described in FIGS. 1 and 2, or the alternative embodiment described in FIGS. 7 and 8.

In order to allow the bicycle to be ridden when the battery is flat, is may be desirable to arrange an emergency mechanism which allows the power-split epicyclic gear mechanism to be by-passed.

FIG. 9 shows an exemplary arrangement of an optional coupling device 42 that is coupled for rotation with the output shaft 25 and may be selectively coupled for rotation also with the planet carrier 6, thereby securing for rotation the output shaft 25 and the pedal shaft 7.

In the exemplary embodiment shown in FIG. 9, the coupling device 42 comprises an externally axially splined tube 42 which slides concentrically within mating splines inside the tubular extension (or output shaft) 25 of the epicyclic sun gear 10. The tube 42 incorporates an external collar 43, which may be accessed externally to the assembly, on a side of the chain-ring 11. Tube 42 also incorporates axial teeth 44, which, when the splined tube 42 is slid into the assembly, engage in mating axial features, such as axial seats or recesses 45 formed in the planetary gear carrier 6. These axially engaging features fulfil the function of a ‘dog-clutch’. When disengaged (FIG. 9A), the power-split device is able to function freely; when engaged (FIG. 9B), motion is transferred directly from the pedal shaft 7 via the planetary carrier 6, and the tube 42 into the tubular output shaft (or sun gear extension) 25 and the chain-ring 11. Hence, although no variable speed ratios or freewheeling functions are available, the bicycle may be ridden with the same functionality as a conventional fixed gear bicycle.

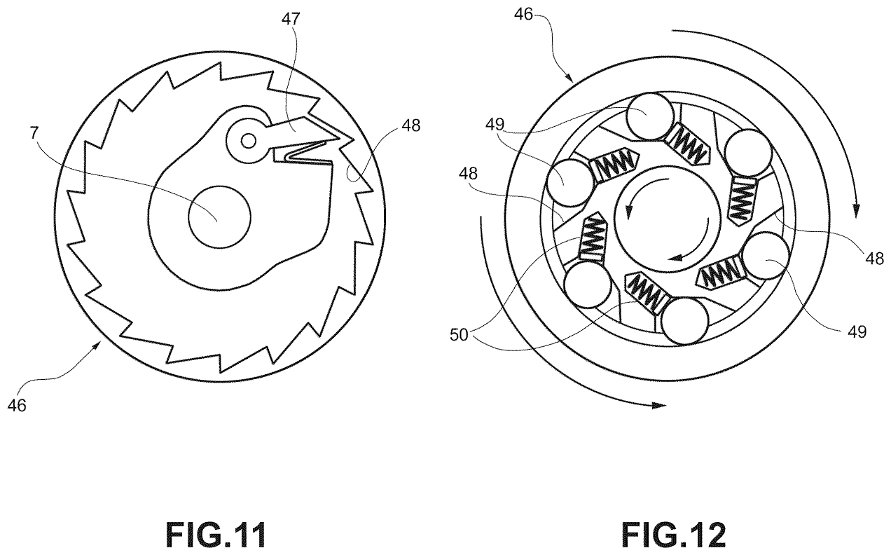

Optionally, a mechanical ‘freewheel’ device 46 may be introduced into the structure, at the connection between the pedal shaft 7 and the planetary gear carrier 6, as shown in FIG. 10. This device may be either a ‘pawl and ratchet’ type mechanism (FIG. 11) where spring loaded pawls 47 engage with a ramped form 48 which is arranged around an internal (or external) diameter. Alternatively, a ‘sprag clutch’ type device may be used (FIG. 12), which employs rolling elements 49 arranged around a ramped cylindrical device 48 and biased by springs 50. The rolling elements 49 lock the device frictionally when the components are rotated relatively in one direction, and provide free relative motion in the opposite direction. The addition of a mechanical freewheel device may enhance the safety of the rider, who could otherwise be surprised by an unexpected rotation of the pedals if a failure within the freewheeling motor control strategy were to occur.

The following advantages and benefits of the present drive system may be appreciated:
the e-bike assistance motor and the means to vary the speed ratio between the pedals and the wheels can be integrated into a single unit which is mid-mounted in the bicycle;
the rear wheel of the bicycle may be completely simplified;
all devices required for changing gears (e.g. derailleur or hub mounted gearbox), gear shifting mechanisms and the freewheeling device may be removed; the removal of mass at the wheel and concentration of mass in the centre of the bike optimises stability;
the drive system offers the opportunity to provide a very wide variable speed ratio range between the pedals and the wheels, within the normal operating speed range of the bicycle;
there is no mechanical shifting mechanism necessary for selecting the speed ratio;
the drive system has only one constantly meshed drive-train, including both the transmission gear mechanism and the chain or belt drive; the present drive system may therefore be optimised for efficiency and durability;
speed ratio selection and torque assistance may be controlled electronically and simultaneously, according to an integrated overall strategy: this potentially allows minimisation of electrical energy use and rider exhaustion, and optimisation of range and rider comfort.

What is claimed is:

1. An electric auxiliary drive system for a bicycle, comprising:
a pedal crankshaft for operation by a rider;
an epicyclic gearing mechanism configured to determine a transmission ratio between the pedal crankshaft and an output shaft for transmitting rotation to a rear wheel of the bicycle, the epicyclic gearing mechanism comprising
a sun gear secured for rotation with the output shaft,
a ring gear,
a set of planet gears between the sun gear and the ring gear, and
a planet carrier secured for rotation with the pedal crankshaft and supporting the planet gears;
an electric assist motor having a rotor drivingly connected to a gear secured to or integral with the sun gear to drive the output shaft; and
an electric control motor, drivingly connected to the ring gear for controlling the transmission ratio between the output shaft and the pedal crankshaft.

2. The electric auxiliary drive system of claim 1, wherein
the gear driven by the rotor of the electric assist motor is an internally toothed peripheral ring gear secured for rotation or integral with the sun gear and the output shaft, and
the epicyclic gearing mechanism further comprises a set of reduction gears acting between the rotor of the electric assist motor and said internally toothed peripheral ring gear.

3. The electric auxiliary drive system of claim 1, wherein the output shaft comprises an axially extending central tubular portion which coaxially surrounds a length of the pedal crankshaft.

4. The electric auxiliary drive system of claim 1, wherein the ring gear provides a dual set of teeth, of which
a first set of teeth is configured to mesh with the planetary gears and
a second set of teeth is configured to mesh with a further set of planetary reduction gears acting between the ring gear and a rotor of the electric control motor.

5. The electric auxiliary drive system of claim 4, wherein the first and second sets of teeth of the ring gear are provided on axially staggered or axially offset portions of the ring gear.

6. The electric auxiliary drive system of claim 1, further comprising a chain-ring integral with the output shaft and having a peripheral shape that allows the chain-ring to drive a sprocket mounted to a rear wheel hub of the bicycle, wherein the chain ring and the sprocket define a transmission ratio that is numerically less than 1.

7. The electric auxiliary drive system of claim 1, wherein the electric control motor and the electric assist motor are axially aligned and concentrically arranged around the pedal crankshaft.

8. The electric auxiliary drive system of claim 1, wherein the electric control motor and the electric assist motor are both arranged radially offset or outside the pedal crankshaft, each of the electric control motor and electric assist motor having a respective rotor drivingly connected with a respective single stage spur gear arrangement for speed reduction.

9. The electric auxiliary drive system of claim 1, further comprising:
a first rotation sensor for sensing rotation of a rotor of the electric control motor;
a second rotation sensor for sensing rotation of the rotor of the electric assist motor;
a torque sensor operatively connected to the pedal crankshaft or the planet carrier to detect a pedalling torque applied to the electric auxiliary drive system by the rider;
an electronic controller electrically connected to said sensors; and
a rechargeable battery unit, electrically connected to the electronic controller.

10. The electric auxiliary drive system of claim 9, wherein the electronic controller is configured for rotating the electric assist motor in a forward direction while rotating the electric control motor in an opposite direction of rotation, in order to spin the gear ring and the sun gear in opposite directions of rotation so as to achieve a freewheeling condition.

11. The electric auxiliary drive system of claim 1, further comprising a coupling device for selectively locking for rotation the sun gear and the planet carrier together.

12. The electric auxiliary drive system of claim 1, further comprising a freewheel device operatively connected to the pedal crankshaft and the planet carrier.
